(19) United States
(12) Patent Application Publication
(10) Pub. No.: US 2020/0275318 A1
(43) Pub. Date: Aug. 27, 2020

(54) COEXISTENCE CONFIGURATION SWITCHING FOR MESH NETWORKS

(71) Applicant: QUALCOMM Incorporated, San Diego, CA (US)

(72) Inventors: Chirag Manojkumar Kharvar, Bangalore (IN); Vasanthavalli Chandran, Bangalore (IN)

(21) Appl. No.: 16/287,163

(22) Filed: Feb. 27, 2019

(51) Int. Cl. H04W 28/20; H04W 84/18; H04W 28/26

(52) U.S. Cl. CPC H04W 28/20; H04W 28/26; H04W 84/18

(57) ABSTRACT

Methods, systems, and devices for wireless communications are described. A device may receive a message associated with traffic, such as wireless local area network (WLAN) traffic and mesh network traffic. The message may include a set of events relate to WLAN traffic and a set of events related to mesh network traffic. The device may compare the set of events of the WLAN traffic and the set of events of the mesh network traffic, and adjust one or more parameters based in part on comparing the sets of events. Accordingly, the device may process at least some of the traffic, such as the mesh network traffic, using the adjusted set of parameters.

### BACKGROUND

The following relates generally to wireless communications, and more specifically to coexistence configuration switching for mesh networks.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems, as well as wireless local area networks (WLAN), such as Wi-Fi (i.e., Institute of Electrical and Electronics Engineers (IEEE) 802.11) and Bluetooth-related technology.

A wireless network, for example a WLAN, such as a Wi-Fi (i.e., Institute of Electrical and Electronics Engineers (IEEE) 802.11) network may include AP that may communicate with one or more stations (STAs). The AP may be coupled to a network, such as the Internet, and may enable a STA to communicate via the network (or communicate with other devices coupled to the AP). A STA may communicate with a network device bi-directionally. For example, in a WLAN, a STA may communicate with an associated AP via downlink and uplink. The downlink (or forward link) may refer to the communication link from the AP to the STA, and the uplink (or reverse link) may refer to the communication link from the STA to the AP.

A STA may also support multiple radio access technologies, such as WLAN, Bluetooth Mesh, Zigbee, Zwave, and the like. In supporting multiple radio access technologies, the STA may experience coexistence problems, which can impact performance on, for example, both WLAN and mesh network traffic. Thus, improved techniques to support coexistence among multiple radio access technologies are desired.

### SUMMARY

Generally, the described techniques support forwarding mesh network traffic related information from a first component to a second component, such as from a host of a station (STA) to a controller of the STA, such that the second component (e.g., the controller of the STA) can determine to adjust a configuration for processing some traffic, such as mesh network traffic, based in part on a type of the traffic. For example, a host of the STA may register itself to receive event information related to both mesh network traffic and wireless local area network (WLAN) traffic. A non-limiting list of example event information may include a provisioning event, a WLAN connection event, a WLAN disconnection event, an enable WLAN radio event, a disable WLAN radio event, a resume WLAN traffic event, or a suspend WLAN traffic event, or any combination thereof, and the like. Based on the events received, the STA may adjust one or more parameters for processing the mesh network traffic, such as adjusting a priority, a bandwidth allocation, a scan duty cycle, or the like for mesh network traffic. The adjusted one or more parameters can then be signaled from the host of the STA to the controller of the STA, so that the controller can adjust a configuration (e.g., a priority, a bandwidth allocation, a scan duty cycle, or the like) for processing the mesh network traffic.

A method of wireless communications at a device is described. The method may include receiving at least one message associated with WLAN traffic and mesh network traffic, the message including a set of events of the WLAN traffic and a set of events of the mesh network traffic, comparing the set of events of the WLAN traffic and the set of events of the mesh network traffic, adjusting a set of parameters based on comparing the set of events of the WLAN traffic and the set of events of the mesh network traffic, and processing the mesh network traffic using the adjusted set of parameters.

An apparatus for wireless communications is described. The apparatus may include a processor, memory in electronic communication with the processor, and instructions stored in the memory. The instructions may be executable by the processor to cause the apparatus to receive at least one message associated with WLAN traffic and mesh network traffic, the message including a set of events of the WLAN traffic and a set of events of the mesh network traffic, compare the set of events of the WLAN traffic and the set of events of the mesh network traffic, adjust a set of parameters based on comparing the set of events of the WLAN traffic and the set of events of the mesh network traffic, and process the mesh network traffic using the adjusted set of parameters.

Another apparatus for wireless communications is described. The apparatus may include means for receiving at least one message associated with WLAN traffic and mesh network traffic, the message including a set of events of the WLAN traffic and a set of events of the mesh network traffic, means for comparing the set of events of the WLAN traffic and the set of events of the mesh network traffic, means for adjusting a set of parameters based on comparing the set of events of the WLAN traffic and the set of events of the mesh network traffic, and means for processing the mesh network traffic using the adjusted set of parameters.

A non-transitory computer-readable medium storing code for wireless communications at a device is described. The code may include instructions executable by a processor to receive at least one message associated with WLAN traffic and mesh network traffic, the message including a set of events of the WLAN traffic and a set of events of the mesh network traffic, compare the set of events of the WLAN traffic and the set of events of the mesh network traffic, adjust a set of parameters based on comparing the set of events of the WLAN traffic and the set of events of the mesh network traffic, and process the mesh network traffic using the adjusted set of parameters.

Some examples of the method, apparatuses, and non-transitory computer-readable medium described herein may further include operations, features, means, or instructions for signaling, by a host of the device to a controller of the device, the set of parameters, and adjusting a configuration of the controller based on at least one parameter of the set of parameters signaled from the host.

Some examples of the method, apparatuses, and non-transitory computer-readable medium described herein may further include operations, features, means, or instructions for adjusting, by the controller of the device, a bandwidth allocation associated with the mesh network traffic or a bandwidth allocation associated with the WLAN traffic, or both based on the signaling received from the host of the device. In some examples of the method, apparatuses, and non-transitory computer-readable medium described herein for processing the mesh network traffic may further include operations, features, means, or instructions for processing, the controller of the device, the mesh network traffic using the adjusted bandwidth allocation associated with the mesh network traffic.

Some examples of the method, apparatuses, and non-transitory computer-readable medium described herein may further include operations, features, means, or instructions for adjusting, by the controller of the device, a scan duty cycle associated with the mesh network traffic or a scan duty cycle associated with the WLAN traffic, or both based on the signaling received from the host of the device. In some examples of the method, apparatuses, and non-transitory computer-readable medium described herein for processing the mesh network traffic may further include operations, features, means, or instructions for processing, by the controller of the device, the mesh network traffic using the adjusted scan duty cycle associated with the mesh network traffic.

Some examples of the method, apparatuses, and non-transitory computer-readable medium described herein may further include operations, features, means, or instructions for identifying, by a host of the device, a packet format associated with one or more packets of the WLAN traffic and a packet format associated with one or more packets of the mesh network traffic, comparing the packet format of the mesh network traffic to the packet format of the WLAN traffic, and assigning, by the host of the device, a higher priority to the one or more packets associated with the mesh network traffic and a lower priority to the one or more packets associated with the WLAN traffic for a duration based on comparing the packet format of the mesh network traffic to the packet format of the WLAN traffic, where adjusting the set of parameters may be based on assigning the priorities.

Some examples of the method, apparatuses, and non-transitory computer-readable medium described herein may further include operations, features, means, or instructions for selecting a length of the duration based on the packet format associated with one or more packets of the mesh network traffic.

Some examples of the method, apparatuses, and non-transitory computer-readable medium described herein may further include operations, features, means, or instructions for identifying, by a host of the device, a type of event associated with at least one event of the set of events of the WLAN traffic and a type of event associated with at least one event of the set of events of the mesh network traffic, and comparing, by the host of the device, the type of event associated with the at least one event of the set of events of the WLAN traffic to the type of event associated with the at least one event of the set of events of the mesh network traffic, where adjusting the set of parameter may be further based on the comparison of the types of events.

In some examples of the method, apparatuses, and non-transitory computer-readable medium described herein, the type of event associated with the at least one event of the set of events of the WLAN traffic may include a WLAN connection event, a WLAN disconnection event, an enable WLAN radio event, a disable WLAN radio event, a resume WLAN traffic event, or a suspend WLAN traffic event, or any combination thereof.

In some examples of the method, apparatuses, and non-transitory computer-readable medium described herein, the type of event associated with the at least one event of the set of events of the mesh network traffic includes an event for provisioning the device to a mesh network.

Some examples of the method, apparatuses, and non-transitory computer-readable medium described herein may further include operations, features, means, or instructions for receiving an indication to provision the device to a mesh network, where at least one event of the set of events of the mesh network traffic includes the provisioning. In some examples of the method, apparatuses, and non-transitory computer-readable medium described herein for adjusting the set of parameters may further include operations, features, means, or instructions for allocating, by a host of the device, a bandwidth to the mesh network traffic based at least in part on the provisioning, and signaling, from the host to a controller of the device, the allocation of the bandwidth using at least an application program interface to signal the controller of the device to adjust the bandwidth allocated to the mesh network traffic.

Some examples of the method, apparatuses, and non-transitory computer-readable medium described herein may further include operations, features, means, or instructions for receiving, by a host of the device, a second message from an application of the device, the second message including instructions to adjust at least one parameter of the set of parameters associated with one or more packets of the mesh network traffic. In some examples of the method, apparatuses, and non-transitory computer-readable medium described herein for adjusting the set of parameters may further include operations, features, means, or instructions for adjusting a priority of the one or more packets of the mesh network traffic based at least in part on the second message, and signaling, from the host to a controller of the device, the adjusted priority using at least an application program interface to signal the controller of the device to adjust the priority of the mesh network traffic.

In some examples of the method, apparatuses, and non-transitory computer-readable medium described herein for receiving the message may include operations, features, means, or instructions for receiving, by a host of the device, the message including the set of events of the WLAN traffic and the set of events of the mesh network traffic.

Some examples of the method, apparatuses, and non-transitory computer-readable medium described herein may further include operations, features, means, or instructions for receiving the WLAN traffic and mesh network traffic via a same radio of the device.

### BRIEF DESCRIPTION OF THE DRAWINGS

FIG. 1 illustrates an example of a wireless communications system that supports coexistence configuration switching for mesh networks in accordance with aspects of the present disclosure.

FIG. 2 illustrates an example of an architecture that supports coexistence configuration switching for mesh networks in accordance with aspects of the present disclosure.

FIG. 3 illustrates an example of a process flow that supports coexistence configuration switching for mesh networks in accordance with aspects of the present disclosure.

FIGS. 4 and 5 show block diagrams of devices that support coexistence configuration switching for mesh networks in accordance with aspects of the present disclosure.

FIG. 6 shows a block diagram of a communications manager that supports coexistence configuration switching for mesh networks in accordance with aspects of the present disclosure.

FIG. 7 shows a diagram of a system including a device that supports coexistence configuration switching for mesh networks in accordance with aspects of the present disclosure.

FIGS. 8 through 10 show flowcharts illustrating methods that support coexistence configuration switching for mesh networks in accordance with aspects of the present disclosure.

### DETAILED DESCRIPTION

A device, such as a station (STA), may support various radio access technologies, such as wireless local area networks (WLAN) and mesh network (e.g., Bluetooth mesh). When operating according to multiple radio access technologies, the STA may be prone to coexistence issues, which may affect performance on, for example, both WLAN and mesh networks. Some techniques try to address these issues, for example, by scheduling WLAN traffic and mesh network traffic according to a type of message. However, these techniques have shortcomings due to the type of message for mesh network traffic always being a same type (e.g., non-connectible advertisement). As a result, the STA may be incapable of distinguishing between the traffic of the non-connectible advertisement from other mesh network traffic, or the like. To address the challenges of coexistence problems when a STA supports multiple radio access technologies (e.g., mesh network and WLAN), the described techniques provide a coexistence configuration switching technique.

Generally, the described techniques support forwarding mesh network traffic related information from a host of a STA to a controller of the STA, such that the controller of the STA can determine to adjust a configuration for processing the mesh network traffic based in part on a type of the mesh network traffic (e.g., type of event). For example, a host of the STA may receive event information related to both mesh network traffic and WLAN traffic. Based on the events received, the STA may adjust one or more parameters for processing the mesh network traffic, such as adjusting a priority, a bandwidth allocation, a scan duty cycle, or the like for mesh network traffic. The adjusted set of parameters can then be signaled from the host of the STA to the controller of the STA, so that the controller can adjust its configuration (e.g., a priority, a bandwidth allocation, a scan duty cycle, or the like) for processing the mesh network traffic. Accordingly, the techniques described herein may provide improvements to coexistence among different radio access technologies, and more specifically coexistence between mesh network and WLAN. The techniques described herein may further provide improved overall throughput between different radio access technologies (e.g., mesh Bluetooth and other radios (e.g., WLAN)) supported by the STA.

Aspects of the disclosure are initially described in the context of a wireless communications system. Aspects of the disclosure are then illustrated by and described with reference to an architecture and a process flow. Aspects of the disclosure are further illustrated by and described with reference to apparatus diagrams, system diagrams, and flowcharts that relate to coexistence configuration switching for mesh networks

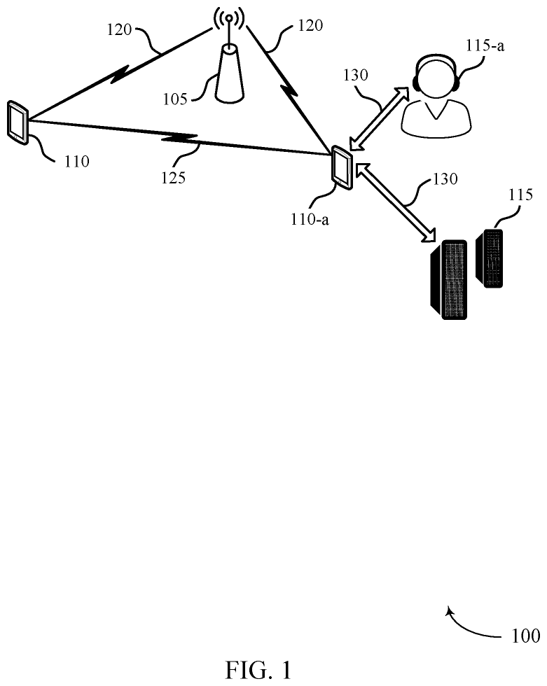

FIG. 1 illustrates a wireless communications system 100 that supports augmented reality language translation in accordance with aspects of the present disclosure. In some examples, the wireless communications system 100 may be a multiple-access wireless communications system, for example, such as a fourth generation (4G) systems such as Long Term Evolution (LTE) systems, LTE-Advanced (LTE-A) systems, or LTE-A Pro systems, and fifth generation (5G) systems which may be referred to as New Radio (NR) systems, as well as wireless local area networks (WLAN), such as Wi-Fi (i.e., Institute of Electrical and Electronics Engineers (IEEE) 802.11) and Bluetooth-related technology. The wireless communications system 100 may include an access point (AP) 105, STAs 110, and paired devices 115 capable of supporting one or more of the examples radio access technologies listed above. For example, STAs 110 may include cell phones, mobile stations, personal digital assistant (PDAs), other handheld devices, netbooks, notebook computers, tablet computers, laptops, or some other suitable terminology. Paired devices 115 may include Bluetooth-enabled devices capable of pairing with other Bluetooth-enabled devices (e.g., such as STAs 110), which may include wireless headsets, earbuds, speakers, ear pieces, headphones, display devices (e.g., TVs, computer monitors), microphones, meters, valves, etc.

A STA 110 may be capable of both mesh (e.g., Bluetooth mesh) and WLAN communications. For example, WLAN and mesh components may be co-located within the STA 110, such that the STA 110 may be capable of communicating according to both mesh and WLAN communication protocols, as each technology may offer different benefits or may improve user experience in different conditions. In some examples, mesh and WLAN communications may share a same medium, such as the same unlicensed frequency medium. In such examples, a STA 110 may support WLAN communications via AP 105 (e.g., over communication links 120). The AP 105 and the associated STAs 110 may represent a basic service set (BSS) or an extended service set (ESS). The various STAs 110 in the network may be able to communicate with one another through the AP 105. In some cases, the AP 105 may be associated with a coverage area, which may represent a basic service area (BSA). The WLAN communications may refer to a communication protocol and may be used to wirelessly connect and exchange information between STAs 110 and paired devices 115, while the mesh communications may refer to a short-range communication protocol and may be used to wirelessly connect and exchange information between devices 110 and paired devices 115 (e.g., between mobile phones, computers, digital cameras, wireless headsets, speakers, keyboards, mice or other input peripherals, and similar devices). In some examples, mesh communications may relate to Bluetooth mesh, which may be beneficial for Internet-of-Things (IoT) applications.

STAs 110 and APs 105 may communicate using a WLAN radio and baseband protocol for physical and MAC layers from IEEE 802.11 and versions including, but not limited to, 802.11b, 802.11g, 802.11a, 802.11n, 802.11ac, 802.11ad, 802.11ah, 802.11ax, etc. In other implementations, peer-to-peer connections or ad hoc networks may be implemented within system 100. AP 105 may be coupled to a network, such as the Internet, and may enable a STA 110 to communicate via the network (or communicate with other STAs 110 coupled to the AP 105). A STA 110 may communicate with a network device bi-directionally. For example, in a WLAN, a STA 110 may communicate with an associated AP 105 via downlink (e.g., the communication link from the AP 105 to the STA110) and uplink (e.g., the communication link from the STA 110 to the AP 105).

Under Bluetooth communications, the wireless communications system 100 may be organized using a master-slave relationship employing a time-division duplex protocol having, for example, defined time slots of 625 mu seconds, in which transmission alternates between the master device (e.g., a STA 110) and one or more slave devices (e.g., paired devices 115). In some examples, a STA 110 may generally refer to a master device, and a paired device 115 may refer to a slave device in the wireless communications system 100. As such, in some examples, a device may be referred to as either a STA 110 or a paired device 115 based on the Bluetooth role configuration of the device. That is, designation of a device as either a STA 110 or a paired device 115 may not necessarily indicate a distinction in device capability, but rather may refer to or indicate roles held by the device in the wireless communications system 100. Generally, the STA 110 may refer to a wireless communication device capable of wirelessly exchanging data signals with another device, and paired device 115 may refer to a device operating in a slave role, or to a short-range wireless device capable of exchanging data signals with the mobile device (e.g., using Bluetooth communication protocols).

A Bluetooth-enabled device may be compatible with certain Bluetooth profiles to use desired services. A Bluetooth profile may refer to a specification regarding an aspect of Bluetooth-based wireless communications between devices. That is, a profile specification may refer to a set of instructions for using the Bluetooth protocol stack in a certain way, and may include information such as suggested user interface formats, particular options and parameters at each layer of the Bluetooth protocol stack, etc. For example, a Bluetooth specification may include various profiles that define the behavior associated with each communication endpoint to implement a specific use case. Profiles may thus generally be defined according to a protocol stack that promotes and allows interoperability between endpoint devices from different manufacturers through enabling applications to discover and use services that other nearby Bluetooth-enabled devices may be offering. The Bluetooth specification defines device role pairs that together form a single use case called a profile. One example profile defined in the Bluetooth specification is the Handsfree Profile (HFP) for voice telephony, in which one device implements an Audio Gateway (AG) role and the other device implements a Handsfree (HF) device role. Another example is the Advanced Audio Distribution Profile (A2DP) for high-quality audio streaming, in which one device (e.g., device 110-a) implements an audio source device (SRC) role and another device (e.g., paired device 115-a) implements an audio sink device (SNK) role.

For a commercial Bluetooth-enabled device that implements one role in a profile to function properly, another device that implements the corresponding role may be present within the radio range of the first device. For example, in order for an HF device such as a Bluetooth headset to function according to the Handsfree Profile, a device implementing the AG role (e.g., a cell phone) may have to be present within radio range. Likewise, in order to stream high-quality mono or stereo audio according to the A2DP, a device implementing the SNK role (e.g., Bluetooth headphones or Bluetooth speakers) may have to be within radio range of a device implementing the SRC role (e.g., a stereo music player).

The Bluetooth specification defines a layered data transport architecture and various protocols and procedures to handle data communicated between two devices that implement a particular profile use case. For example, various logical links are available to support different application data transport requirements, with each logical link associated with a logical transport having certain characteristics (e.g., flow control, acknowledgement mechanisms, repeat mechanisms, sequence numbering, scheduling behavior, etc.). The Bluetooth protocol stack may be split in two parts: a controller stack including the timing critical radio interface, and a host stack handling high level data. The controller stack may be generally implemented in a low-cost silicon device including a Bluetooth radio and a microprocessor. The controller stack may be responsible for setting up links 130 such as ACL logical transport channels (also referred to herein as ACL links or ACL connections), synchronous connection orientated (SCO) logical transport channels (also referred to herein as SCO links or SCO connections), eSCO transport channels (also referred to herein as eSCO links or eSCO connections), etc.

In some examples, the controller stack may implement link management protocol (LMP) functions, low energy link layer (LELL) functions, etc. The host stack may be generally implemented as part of an operating system, or as an installable package on top of an operating system. The host stack may be responsible for logical link control and adaptation protocol (L2CAP) functions, Bluetooth network encapsulation protocol (BNEP) functions, service discovery protocol (SDP) functions, etc. In some examples, the controller stack and the host stack may communicate via a host controller interface (HCI). In other cases, (e.g., for integrated devices such as Bluetooth headsets), the host stack and controller stack may be run on the same microprocessor to reduce mass production costs. For such host-less systems, the HCI may be optional, and may be implemented as an internal software interface.

A link 130 established between two Bluetooth-enabled devices (e.g., between a STA 110-a and a paired device 115-a) may provide for communications or services (e.g., according to some Bluetooth profile). For example, a Bluetooth connection may be an eSCO connection for voice call (e.g., which may allow for retransmission), an ACL connection for music streaming (e.g., A2DP), etc. For example, eSCO packets may be transmitted in predetermined time slots (e.g., 6 Bluetooth slots each for eSCO). The regular interval between the eSCO packets may be specified when the Bluetooth link is established. The eSCO packets to/from a specific slave device (e.g., paired device 115-a) are acknowledged, and may be retransmitted if not acknowledged during a retransmission window. In addition, audio may be streamed between the STA 110-a and paired device 115-a using an ACL connection (A2DP profile). In some cases, the ACL connection may occupy 1, 3, or 5 Bluetooth slots for data or voice. Other Bluetooth profiles supported by Bluetooth-enabled devices may include Bluetooth Low Energy (BLE) (e.g., providing considerably reduced power consumption and cost while maintaining a similar communication range), human interface device profile (HID) (e.g., providing low latency links with low power requirements), etc.

A STA 110 supporting mesh operations may be used in either a gateway role or a device role. A STA 110 operating in the gateway role may receive information from other devices, which may be STAs 110 (e.g., operating in a device role) and forward the information to a cloud (e.g., a server, a database). When a STA 110 operates in a device role, a mesh radio (e.g., a Bluetooth radio) may be sufficient for communications, however for the gateway role (e.g., a bridge between multiple radio access technologies, like WLAN), the STA 110 may have to support additional radios (e.g., WLAN) to connect the STA 110 to the Internet for cloud support. In supporting multiple radio access technologies, however, the STAs 110 may be susceptible to various coexistence problems, which can impact performance on both mesh and WLAN traffic.

In some examples, to address the coexistence issue, because a STA 110 may support multiple radio access technologies (e.g., both mesh and WLAN), the STA 110 may be configured with a radio component (e.g., a combined mesh and WLAN chip), so that when the STA 110 operates in a gateway role the STA 110 may be capable of supporting the multiple radio access technologies. As a result, the multiple radio access technologies (e.g., both mesh and WLAN) may share a same channel, as well as a same radio, which leads to sharing a bandwidth. Some techniques make an effort to further address the coexistence problems, by scheduling WLAN traffic and mesh network traffic according to a type of message.

For example, a STA 110 may support different scheduling algorithms that are applicable to the mesh network traffic and WLAN traffic, and other radios (e.g., if the STA 110 supports other radio access technologies) based in part on a type of message. However, for mesh network traffic (e.g., a Bluetooth mesh network traffic) the type of the message may always be non-connectible advertisements (NONCON_ADV_IND). In this case, the scheduling algorithm may be incapable of distinguishing whether the traffic of the advertisement is mesh network traffic (which is meant for different use cases) or something else. Thus, these techniques have shortcomings due to the type of message for mesh network traffic always being a same type (e.g., non-connectible advertisement). As a result, the STAs 110 may be unable to discern the traffic of the non-connectible advertisement from other mesh network traffic, or the like.

Mesh network traffic may also have different use cases and models associated with it, and each use case and/or model may have different requirements for processing (e.g., scanning, transmitting, and receiving). The term “use case” may also be referred to herein as “an event” or “a set of events”, while the term “model” may be referred to herein as a “format” (e.g., a packet format). A host stack of a STA 110 may be configurable to adjust a set of parameters according to a set of events of WLAN traffic and a set of events of mesh network traffic. If this information (e.g., the adjusted set of parameters) is not passed to a controller stack of the STA 110, the controller stack may continue to use a same configuration (e.g., a scan duty cycle related to mesh network traffic, a bandwidth allocation related to mesh network traffic, a priority of mesh network traffic, and the like based in part on certain use cases and models associated with mesh network traffic) indefinitely for different operations. When a STA 110 operates under a gateway role, the STA 110 may have to support several different events of mesh network traffic, while at the same time handling several different WLAN traffic. Hence, if the above-referenced information (e.g., adjusted set of parameters) is not forwarded to a controller stack of the STA 110, the controller stack of the STA 110 may end up favoring one radio (e.g., a WLAN radio) over another radio (e.g., a Bluetooth mesh radio).

Mesh network traffic requirements may change based in part on a type of event or format (e.g., packet format). An example event (e.g., use case) may require a lower scan duty cycle compared to a default scan duty cycle for a STA 110 because the STA 110 may occasionally receive fewer packets than normal (e.g., a number of packets below a threshold). The default scan duty cycle may include continuously scanning a medium (e.g., different channels, different frequencies) for one or more packets designated for the STA 110. In this example, a radio (e.g., a Bluetooth mesh radio) of the STA 110 may use more bandwidth than necessary, of which a portion of the unused bandwidth could have been allocated to other radios like WLAN (or ZigBee).

In another example event, mesh network traffic may include one or more control commands. In this case, the mesh network traffic becomes of higher priority compared to other traffic types (e.g., WLAN traffic), and hence the STA 110 (e.g., a scheduler of the STA 110) may assign the mesh network traffic a higher priority for a limited time. In standing scenarios, any messages (e.g., even the control command(s)) associated with the mesh network traffic may be identified, by a scheduler in the controller stack of the STA 110, as a non-connectible advertisement transmission. Thus, the mesh network traffic may be processed according to a lower priority compared to other traffic types. In other examples, an event may be a provisioning event to provision the STA 110 to a mesh network. Here, the STA 110 may require no disturbances from other radios, such as WLAN. Thus, the STA 110 may assign a higher priority to mesh network traffic over WLAN traffic for a period of time, which can be reverted once the provisioning is completed. This is to ensure a smooth provisioning experience for the STA 110.

A STA 110 may control one or more parameters, such as a scan duty cycle related to mesh network traffic, a bandwidth allocation related to mesh network traffic, a priority of mesh network traffic, and the like, based in part on certain use cases and models associated with mesh network traffic. To support control of the one or more parameters, a host stack of a STA 110 may expose a controller stack of the STA 110 to mesh network traffic. That is, the host stack of the STA 110 may pass mesh network traffic related information to the controller stack of the STA 110, so that the controller stack can perform decision based in part on mesh network traffic (e.g., set of events and a type of each event of the set of events). In an example, a STA 110 may use vendor specific HCI commands to signal the mesh network traffic related information from the host stack to the controller stack.

In another example, the STA 110 may configure different parameters based in part on certain events associated with mesh network traffic and WLAN traffic using application program interface (APIs) supported by a platform. These configurations support different parameters which can be changed in run time (e.g., one configuration may support changing an amount of bandwidth allocated to mesh network traffic over WLAN traffic by changing a parameter of the configuration). Thus, the techniques described herein support a controller stack of a STA 110 that may be configurable to adjust a configuration based in part on mesh network traffic related information (e.g., a set of parameters) passed from the host stack of the STA 110.

Accordingly, the techniques described herein may provide improvements to coexistence among different radio access technologies, and more specifically coexistence between mesh network and WLAN. Furthermore, the techniques described herein may provide benefits and enhancements to the operation of the STAs 110 and the paired devices 115. For example, by supporting effective techniques for coexistence configuration switching, the operational characteristics, such as power consumption, processor utilization, memory usage, and latencies of the STAs 110 and the paired devices 115 may be reduced. The techniques described herein may also provide efficiency to the STAs and the paired devices 115 by reducing latency associated with processes related to communicating mesh network traffic and WLAN traffic.

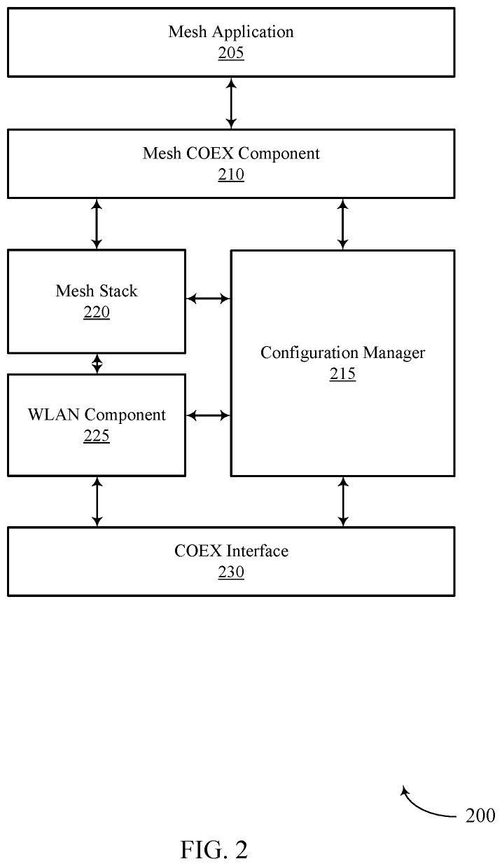

FIG. 2 illustrates an example of an architecture 200 that supports coexistence configuration switching for mesh networks in accordance with aspects of the present disclosure. In some examples, the architecture 200 may implement aspects of the wireless communications system 100. For example, a STA 110 may include one or more components to implement or include aspects of the architecture 200. The architecture 200 may include a mesh application 205, a mesh COEX component 210, a configuration manager 215, a mesh stack 220, a WLAN component 225, and a COEX interface 230, which may be examples of the corresponding devices or components described with reference to FIGS. 1, 2 and 4 through 7. In some examples, the mesh application 205, the mesh COEX component 210, the configuration manager 215, the mesh stack 220, the WLAN component 225, or the COEX interface 230, or a combination thereof may be part of a host stack (or higher layers of a protocol stack) of the STA 110. Alternatively, in some examples, the mesh application 205, the mesh COEX component 210, the configuration manager 215, the mesh stack 220, the WLAN component 225, or the COEX interface 230, or a combination thereof may be part of a controller stack (or lower layers of a protocol stack) of the STA 110. Each of the mesh application 205, the mesh COEX component 210, the configuration manager 215, the mesh stack 220, the WLAN component 225, or the COEX interface 230, or a combination thereof may communicate, directly or indirectly, with one another (e.g., via one or more protocols (e.g., a host controller interface (HCI) protocol), buses). Certain components may also be omitted from the architecture 200, and/or other components may be added to the architecture 200.

The mesh COEX component 210 may be added into the architecture 200 (e.g., a mesh stack). In some examples, the mesh COEX component 210 may be positioned between the mesh application 205 and the mesh (core) stack 220 and reside above the WLAN component 225. The mesh COEX component 210 may register itself to receive events from both the mesh stack 220 and the WLAN component 225. Thus, based in part on the events received from the mesh stack 220 and the WLAN component 225, the mesh COEX component 210 may communicate with the configuration manager 215 using one or more APIs published for coexistence configuration switching. For example, the mesh COEX component 210 may inform the configuration manager 215 to adjust one or more parameters provided by the mesh COEX component 210 for a controller of the STA 110. These parameters may include adjusting a mesh network traffic priority in a scheduler, adjusting a mesh advertisement message priority based in part on certain mesh use case and/or models, adjust a bandwidth of the mesh network traffic for a limited period, or adjusting a scan duty cycle, and the like. In some examples, the mesh COEX component 210 may use one or more parameters individually or combined. The decision to choose one or more parameters to adjust may be dependent on the use case or a model being addressed in the mesh stack 220.

By way of example, the mesh COEX component 210 may receive at least one message associated with WLAN traffic and/or mesh network traffic. The message may include a set of events of the WLAN traffic and a set of events of the mesh network traffic. For example, the mesh COEX component 210 may receive a message from the mesh stack 220 including a set of events of the mesh network traffic, and a second message from the WLAN component 225 including a set of events of the WLAN traffic. The mesh COEX component 210 may compare the set of events of the WLAN traffic and/or the set of events of the mesh network traffic, and adjust a set of parameters based in part on the comparison.

The mesh COEX component 210 may then transmit the adjusted set of parameters to the configuration manager 215. For example, the mesh COEX component 210 may signal an adjusted bandwidth allocation, an adjusted scan duty cycle, or an adjusted priority, or a combination thereof associated with mesh network traffic or a radio (e.g., transceiver 730, antenna 735) of the STA 110 that handles the mesh network traffic to the configuration manager 215. In some examples, the mesh COEX component 210 may transmit the adjusted set of parameters to the configuration manager 215, so that the configuration manager 215 may signal to a controller (e.g., a controller stack) of the STA 110 to change a configuration of the controller based in part on the adjusted set of parameters. In some examples, the mesh COEX component 210 may signal the adjusted set of parameters (e.g. to the configuration manager 215) using one or more APIs (e.g., provided by a platform of the STA 110) to change the configuration of the controller of the STA 110.

At the controller of the STA 110, the controller may adjust a bandwidth allocation associated with the mesh network traffic or a bandwidth allocation associated with the WLAN traffic, or both based in part on the signaling received from the host of the STA 110 (e.g., via the configuration manager 215). In this example, the controller of the STA 110 may process the mesh network traffic using the adjusted bandwidth allocation associated with the mesh network traffic. Additionally, or alternatively, the controller of the STA 110 may adjust a scan duty cycle associated with the mesh network traffic or a scan duty cycle associated with the WLAN traffic, or both based in part on the signaling received from the host of the STA 110 (e.g., via the configuration manager 215 and COEX interface 230). In this example, the controller of the STA 110 may process the mesh network traffic using the adjusted scan duty cycle associated with the mesh network traffic.

In some examples, the mesh COEX component 210 may identify a packet format associated with one or more packets of the WLAN traffic and a packet format associated with one or more packets of the mesh network traffic, and compare the packet format of the mesh network traffic to the packet format of the WLAN traffic. Based in part on the comparison, the mesh COEX component 210 may assign a higher priority to the one or more packets associated with the mesh network traffic and a lower priority to the one or more packets associated with the WLAN traffic for a duration.

In some examples, the mesh COEX component 210 may select a length of the duration based in part on the packet format associated with one or more packets of the mesh network traffic. For example, a first packet format may be associated with a first duration and a second packet format different from the first packet format may be associated with a second duration. In some examples, the first duration may be longer or shorter than the second duration.

Here, the adjusted set of parameters may include an adjusted priority. Thus, the mesh COEX component 210 may then transmit the adjusted priority in the set of parameters to the configuration manager 215. For example, the mesh COEX component 210 may signal an adjusted priority associated with mesh network traffic or a radio (e.g., transceiver 730, antenna 735) of the STA 110 that handles the mesh network traffic to the configuration manager 215. In some examples, the mesh COEX component 210 may transmit the adjusted priority in the set of parameters to the configuration manager 215, so that the configuration manager 215 may signal to a controller (e.g., a controller stack) of the STA 110 to change a configuration (e.g., a priority of traffic handling) of the controller based in part on the adjusted priority in the set of parameters. In some examples, the mesh COEX component 210 may signal the adjusted priority in the set of parameters to the configuration manager 215 using one or more APIs (e.g., provided by a platform of the STA 110) to change the configuration of the controller of the STA 110.

The mesh COEX component 210 may additionally, or alternatively, identify a type of event associated with at least one event of the set of events of the WLAN traffic and a type of event associated with at least one event of the set of events of the mesh network traffic. The type of event associated with the at least one event of the set of events of the WLAN traffic may include a WLAN connection event, a WLAN disconnection event, an enable WLAN radio event, a disable WLAN radio event, a resume WLAN traffic event, or a suspend WLAN traffic event, or any combination thereof. The type of event associated with the at least one event of the set of events of the mesh network traffic may include an event for provisioning the STA 110 to a mesh network.

The mesh COEX component 210 may then compare the type of event associated with the at least one event of the set of events of the WLAN traffic to the type of event associated with the at least one event of the set of events of the mesh network traffic for adjusting the set of parameters. For example, the mesh COEX component 210 may determine to allocate a certain bandwidth to mesh network traffic, or a priority to the mesh network traffic, or a scan duty cycle associated with mesh network traffic or a radio (e.g., transceiver 730, antenna 735) of the STA 110 that handles the mesh network traffic based in part on the type of event. Similarly, the mesh COEX component 210 may determine to allocate a certain bandwidth to the WLAN traffic, or a priority to the WLAN traffic, or a scan duty cycle associated with WLAN traffic or a radio (e.g., transceiver 730, antenna 735) of the STA 110 that handles the WLAN traffic based in part on the type of event.

In an example, the mesh COEX component 210 may receive an indication to provision the STA 110 to a mesh network. Here, at least one event of the set of events of the mesh network traffic may include the provisioning. The mesh COEX component 210 may allocate a bandwidth to the mesh network traffic based in part on the provisioning, and signal the allocation of the bandwidth using at least an API to signal the controller of the STA 110 to adjust the bandwidth allocated to the mesh network traffic (e.g., by signaling the allocation of the bandwidth to the configuration manager 215, which may signal the controller of the STA 110 to change its configuration by providing the adjusted parameter (e.g., bandwidth allocation) via the COEX interface 230).

In other examples, the mesh COEX component 210 may receive a second message from an application of the STA 110. The second message may include instructions to adjust at least one parameter of the set of parameters associated with one or more packets of the mesh network traffic.

Here, the mesh COEX component 210 may adjust a priority of the one or more packets of the mesh network traffic based in part on the second message, and signal the adjusted priority using at least an API to signal the controller of the STA 110 to adjust the priority of the mesh network traffic. For example, a mesh application may be a smart home application related to a smart home system and the message may be to perform an operation associated with the smart home system (e.g., unlocking or locking a door).

In this example, the mesh COEX component 210 may identify an event type and adjust at least one parameter of the set of parameters associated with the message (e.g., the mesh network traffic) and signal the adjusted priority using at least an API to signal the controller of the STA 110 to adjust the priority of the mesh network traffic. Thus, based in part on receiving a message from the mesh application 205 directly, the mesh COEX component 210 may reduce the latencies associated with processing the message (e.g., the mesh network traffic).

The techniques described herein may provide improvements to coexistence among different radio access technologies, and more specifically coexistence between mesh network and WLAN. Furthermore, the techniques described herein may provide improved overall throughput between mesh (e.g., Bluetooth) and other radios (e.g., WLAN) supported by STAs 110 acting under a gateway role. Additionally, latency associated with processes related to communicating mesh network traffic and WLAN traffic may be configurable to the requirement of the use cases. The techniques described herein may also provide flexibility for applications to override or add new events for the coexistence configuration switching and receive decisions directly from the application.

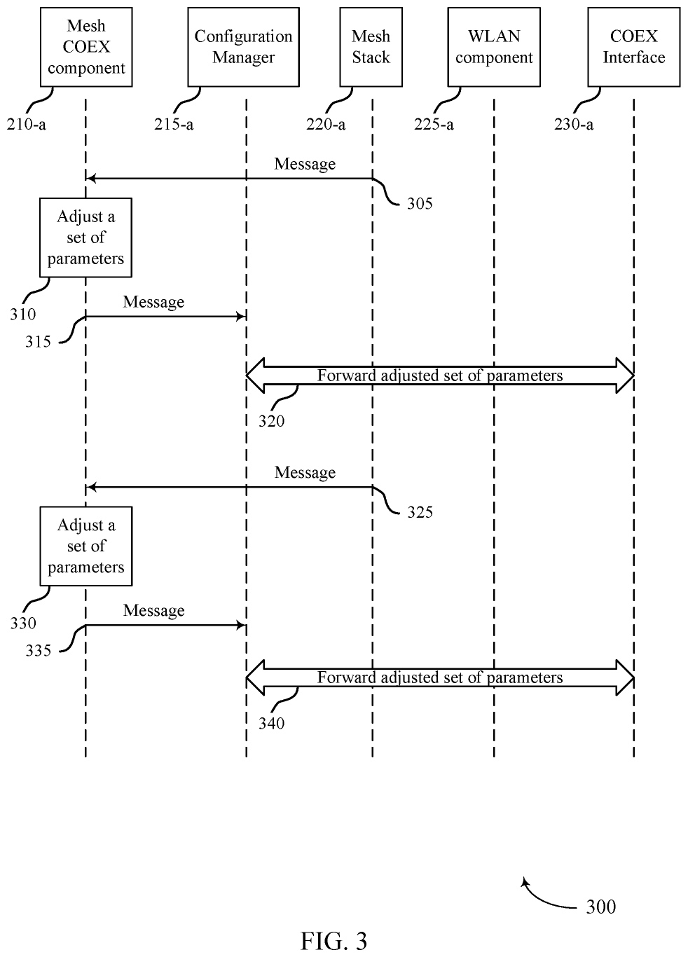

FIG. 3 illustrates an example of a process flow 300 that supports coexistence configuration switching for mesh networks in accordance with aspects of the present disclosure. In some examples, the process flow 300 may implement aspects of wireless communications system 100. For example, the process flow 300 may illustrate an example of a provisioning procedure according to the coexistence configuration switching for mesh networks. In some examples, a STA 110 may perform a provisioning procedure to add itself to a mesh network (e.g., a Bluetooth mesh network).

The process flow 300 may include a mesh COEX component 210-a, a configuration manager 215-a, a mesh stack 220-a, a WLAN component 225-a, and a COEX interface 230-a, which may be examples of the corresponding devices or components described with reference to FIGS. 1, 2 and 4 through 7. In some examples, the mesh COEX component 210-a, the configuration manager 215-a, the mesh stack 220-a, the WLAN component 225-a, or the COEX interface 230-a, or a combination thereof may be part of a host stack of the STA 110. Alternatively, in some examples, the mesh COEX component 210-a, the configuration manager 215-a, the mesh stack 220-a, the WLAN component 225-a, or the COEX interface 230-a, or a combination thereof may be part of a controller stack of the STA 110.

In the following description of the process flow 300, the operations between the mesh COEX component 210-a, the configuration manager 215-a, the mesh stack 220-a, the WLAN component 225-a, and the COEX interface 230-a may be transmitted in a different order than the exemplary order shown, or the operations performed by the mesh COEX component 210-a, the configuration manager 215-a, the mesh stack 220-a, the WLAN component 225-a, and the COEX interface 230-a may be performed in different orders or at different times. Certain operations may also be omitted from the process flow 300, and/or other operations may be added to the process flow 300.

At 305, the process flow 300 may commence with the mesh stack 220-a transmitting a message to the mesh COEX component 210-a of a provisioning event. For example, the mesh stack 220-a may transmit a packet including an indication (e.g., in a field of a header of the packet) identifying an event, such as the provisioning event.

At 310, the mesh COEX component 210-a may receive the message and adjust a set of parameters. For example, the mesh COEX component 210-a may adjust a bandwidth allocation, a scan duty cycle, or a priority, or a combination thereof associated with mesh network traffic or a radio (e.g., transceiver 730, antenna 735) of the STA 110 that handles the mesh network traffic.

In some instances, adjusting a bandwidth allocation may include the mesh COEX component 210-a allocating a portion (e.g., a percentage) of a bandwidth to the mesh network traffic. For example, the mesh COEX component 210-a may allocate 80% of a system bandwidth for the mesh network traffic or the radio (e.g., transceiver 730, antenna 735) of the STA 110 that handles the mesh network traffic during the provisioning event. That is, the mesh COEX component 210-a may temporally (e.g., for a limited duration) allocate a higher bandwidth to the mesh network traffic based in part on the provisioning event, so that the STA 110 may experience a seamless provisioning event when adding itself (e.g., joining) to a mesh network.

At 315, the mesh COEX component 210-a may transmit the adjusted set of parameters to the configuration manager 215-a. For example, the mesh COEX component 210-a may signal an adjusted bandwidth allocation, an adjusted scan duty cycle, or an adjusted priority, or a combination thereof associated with mesh network traffic or a radio (e.g., transceiver 730, antenna 735) of the STA 110 that handles the mesh network traffic to the configuration manager 215-a.

In some examples, the mesh COEX component 210-a may transmit the adjusted set of parameters to the configuration manager 215-a, so that the configuration manager 215-a may signal to a controller (e.g., a controller stack) of the STA 110 to change a configuration of the controller based in part on the adjusted set of parameters. In some examples, the mesh COEX component 210-a may signal the adjusted set of parameters to the configuration manager 215-a using one or more APIs (e.g., provided by a platform of the STA 110) to change the configuration of the controller of the STA 110. Applications may be given certain APIs, so that the mesh COEX component 210-a may be aware of different indications for changing different parameters for a scheduler of the STA 110 (e.g., a scheduler of the controller of the STA 110).

At 320, the configuration manager 215-a may receive the adjusted set of parameters from the mesh COEX component 210-a, and forward the adjusted set of parameters) to the controller of the STA 110, so that the controller can adjust its configuration (e.g., set of parameters) to the ones provided by the mesh COEX component 210-a. For example, the controller of the STA 110 may adjust a bandwidth allocation associated with the mesh network traffic based in part on the adjusted set of parameters, so that the controller of the STA 110 may process the mesh network traffic accordingly (e.g., using the adjusted bandwidth allocation).

At 325, the mesh stack 220-a may transmit a second message to the mesh COEX component 210-a of a provisioning complete event. For instance, the mesh stack 220-a may transmit a packet including an indication (e.g., in a field of a header of the packet) associated with the provisioning event. For example, the mesh stack 220-a may transmit a packet including an indication (e.g., in a field of a header of the packet) identifying a completion of the provisioning event.

At 330, the mesh COEX component 210-a may receive the second message and adjust the set of parameters. For example, the mesh COEX component 210-a may adjust a bandwidth allocation, a scan duty cycle, or a priority, or a combination thereof associated with mesh network traffic or a radio (e.g., transceiver 730, antenna 735) of the STA 110 that handles the mesh network traffic. In the example of a provisioning complete event, adjusting a bandwidth allocation may include the mesh COEX component 210-a allocating a smaller portion (e.g., a smaller percentage) of the bandwidth to the mesh network traffic when the STA 110 is not performing a provisioning event. As an example, the mesh COEX component 210-a may adjust a bandwidth allocation from 80% of the system bandwidth to 50% of the system bandwidth for the mesh network traffic or the radio (e.g., transceiver 730, antenna 735) of the STA 110 that handles the mesh network traffic. As such, the mesh COEX component 210-a may reduce a bandwidth allocation of the mesh network traffic when appropriate, so that the system bandwidth is shared between different traffic handled by the STA 110.

At 335, the mesh COEX component 210-a may transmit the adjusted set of parameters to the configuration manager 215-a. For example, the mesh COEX component 210-a may signal an adjusted bandwidth allocation, an adjusted scan duty cycle, or an adjusted priority, or a combination thereof associated with mesh network traffic or a radio (e.g., transceiver 730, antenna 735) of the STA 110 that handles the mesh network traffic to the configuration manager 215-a. As outlined above, the mesh COEX component 210-a may transmit the adjusted set of parameters to the configuration manager 215-a, so that the configuration manager 215-a may signal to a controller (e.g., a controller stack) of the STA 110 to change a configuration of the controller based in part on the adjusted set of parameters.

For example, the mesh COEX component 210-a may signal the adjusted set of parameters to the configuration manager 215-a using one or more APIs (e.g., provided by a platform of the STA 110) to change the configuration of the controller of the STA 110

At 340, the configuration manager 215-a may receive the adjusted set of parameters from the mesh COEX component 210-a, and forward the adjusted set of parameters) to the controller of the STA 110, so that the controller can adjust its configuration (e.g., set of parameters) to the ones provided by the mesh COEX component 210-a. For example, the controller of the STA 110 may adjust a bandwidth allocation (e.g., from 80% to 50% bandwidth allocation) associated with the mesh network traffic based in part on the adjusted set of parameters, so that the controller of the STA 110 may process the mesh network traffic accordingly (e.g., using the adjusted bandwidth allocation).

Therefore, the operations described in the process flow 300 may provide a seamless provisioning experience for the STA 110 even when WLAN traffic is running in the background. The operations described in the process flow 300 may also provide improvements to coexistence among different radio access technologies, and more specifically coexistence between mesh network and WLAN. For example, the operations described in the process flow 300 may provide one of many examples where supports coexistence configuration switching can be used to improve performance of certain use cases (e.g., event types) for mesh network traffic, while having minimal impact on WLAN traffic, or other radio access technology traffic throughput. Although the operations described in the process flow 300 are described as relating to a provisioning event, other event types may be supported for which the mesh COEX component 210-a can be used to switch to different configurations for the controller of the STA 110. A non-limiting list of examples may include switching configurations based in part on WLAN events such as WLAN connection, WLAN disconnection, enable or disable, resume or suspend, and the like, switching configurations based in part on certain models being used (e.g., packet formats), switching configurations based in part on an event type being entertained by the STA 110 at a given time, or switching configurations based in part on instructions given from an application running on the STA 110, or a combination thereof.

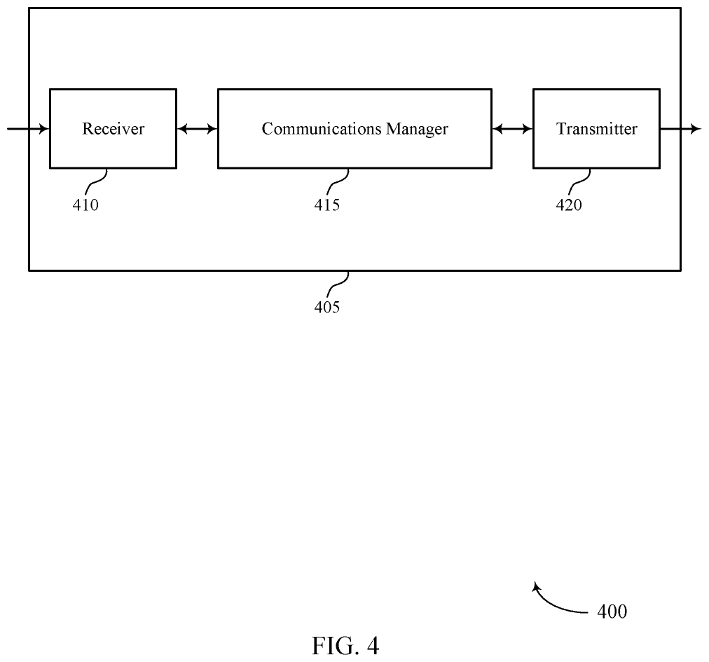

FIG. 4 shows a block diagram 400 of a device 405 that supports coexistence configuration switching for mesh networks in accordance with aspects of the present disclosure. The device 405 may be an example of aspects of a STA as described herein. The device 405 may include a receiver 410, a communications manager 415, and a transmitter 420. The device 405 may also include a processor. Each of these components may be in communication with one another (e.g., via one or more buses).

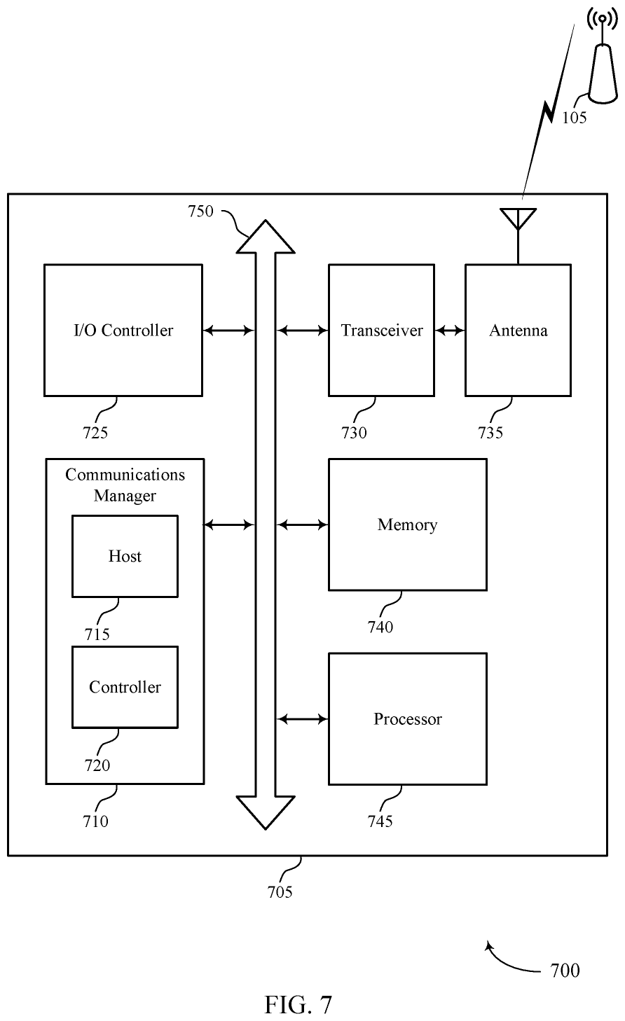

Receiver 410 may receive information such as packets, user data, or control information associated with various information channels (e.g., control channels, data channels, and information related to coexistence configuration switching for mesh networks, etc.). Information may be passed on to other components of the device. The receiver 410 may be an example of aspects of the transceiver 730 described with reference to FIG. 7. The receiver 410 may utilize a single antenna or a set of antennas.

The communications manager 415 may receive at least one message associated with WLAN traffic and mesh network traffic, the message including a set of events of the WLAN traffic and a set of events of the mesh network traffic, compare the set of events of the WLAN traffic and the set of events of the mesh network traffic, adjust a set of parameters based on comparing the set of events of the WLAN traffic and the set of events of the mesh network traffic, and process the mesh network traffic using the adjusted set of parameters. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Transmitter 420 may transmit signals generated by other components of the device. In some examples, the transmitter 420 may be collocated with a receiver 410 in a transceiver module. For example, the transmitter 420 may be an example of aspects of the transceiver 730 described with reference to FIG. 7. The transmitter 420 may utilize a single antenna or a set of antennas.

As detailed above, the communications manager 415 and/or one or more components of the communications manager 415 may perform and/or be a means for performing, either alone or in combination with other elements, one or more operations for supporting coexistence configuration switching for mesh networks.

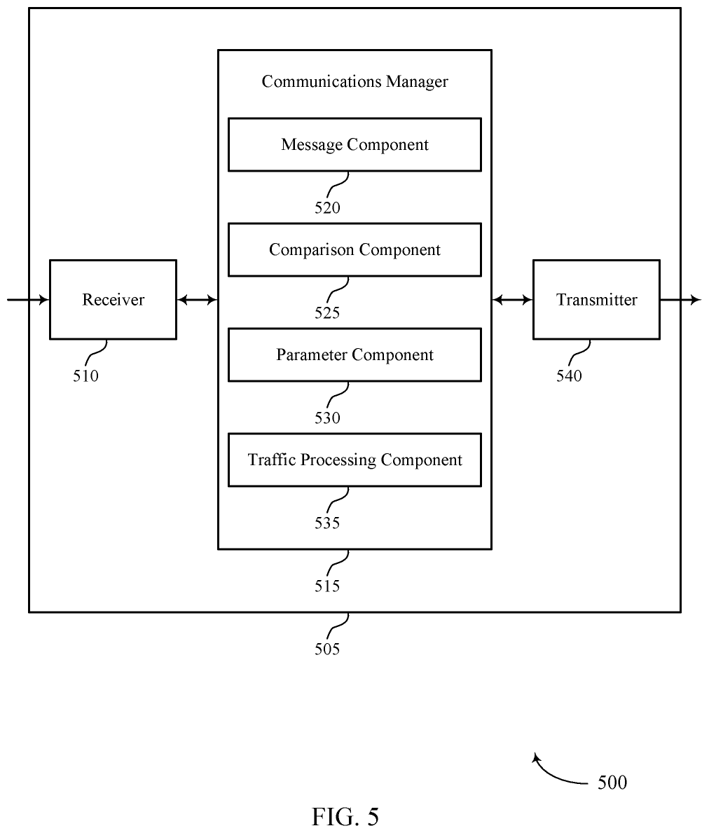

FIG. 5 shows a block diagram 500 of a device 505 that supports coexistence configuration switching for mesh networks in accordance with aspects of the present disclosure. The device 505 may be an example of aspects of a device 405 or a STA 110 as described herein. The device 505 may include a receiver 510, a communications manager 515, and a transmitter 540. The device 505 may also include a processor. Each of these components may be in communication with one another (e.g., via one or more buses).

Receiver 510 may receive information such as packets, user data, or control information associated with various information channels (e.g., control channels, data channels, and information related to coexistence configuration switching for mesh networks, etc.). Information may be passed on to other components of the device. The receiver 510 may be an example of aspects of the transceiver 730 described with reference to FIG. 7. The receiver 510 may utilize a single antenna or a set of antennas.

The communications manager 515 may be an example of aspects of the communications manager 415 as described herein. The communications manager 515 may include a message component 520, a comparison component 525, a parameter component 530, and a traffic processing component 535. The communications manager 515 may be an example of aspects of the communications manager 710 described herein.

The message component 520 may receive at least one message associated with WLAN traffic and mesh network traffic, the message including a set of events of the WLAN traffic and a set of events of the mesh network traffic. The comparison component 525 may compare the set of events of the WLAN traffic and the set of events of the mesh network traffic. The parameter component 530 may adjust a set of parameters based on comparing the set of events of the WLAN traffic and the set of events of the mesh network traffic. The traffic processing component 535 may process the mesh network traffic using the adjusted set of parameters.

Transmitter 540 may transmit signals generated by other components of the device. In some examples, the transmitter 540 may be collocated with a receiver 510 in a transceiver module. For example, the transmitter 540 may be an example of aspects of the transceiver 730 described with reference to FIG. 7. The transmitter 540 may utilize a single antenna or a set of antennas.

As detailed above, the communications manager 515 and/or one or more components of the communications manager 515 may perform and/or be a means for performing, either alone or in combination with other elements, one or more operations for supporting coexistence configuration switching for mesh networks.

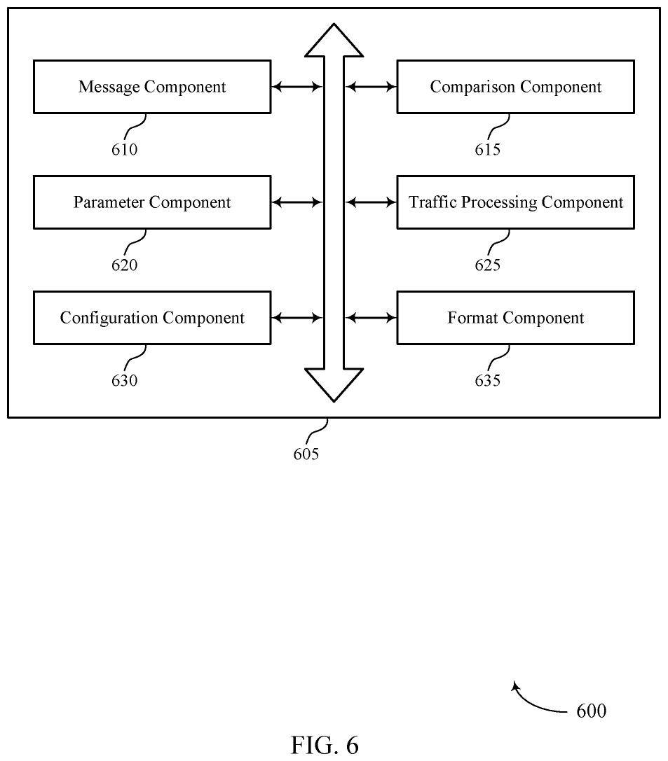

FIG. 6 shows a block diagram 600 of a communications manager 605 that supports coexistence configuration switching for mesh networks in accordance with aspects of the present disclosure. The communications manager 605 may be an example of aspects of a communications manager 415, a communications manager 515, or a communications manager 710 described herein. The communications manager 605 may include a message component 610, a comparison component 615, a parameter component 620, a traffic processing component 625, a configuration component 630, and a format component 635. Each of these modules may communicate, directly or indirectly, with one another (e.g., via one or more buses). In some examples, the communications manager 605 may be an example of aspects of a device as described herein.

The message component 610 may receive at least one message associated with WLAN traffic and mesh network traffic. The message may include a set of events of the WLAN traffic and a set of events of the mesh network traffic. The message component 610 may receive, by a host of the device, the message including the set of events of the WLAN traffic and the set of events of the mesh network traffic. In some examples, the message component 610 may identify, by a host of the device, a type of event associated with at least one event of the set of events of the WLAN traffic and a type of event associated with at least one event of the set of events of the mesh network traffic. The message component 610 may receive an indication to provision the device to a mesh network, where at least one event of the set of events of the mesh network traffic includes the provisioning.

In some examples, the message component 610 may receive, by a host of the device, a second message from an application of the device, the second message including instructions to adjust at least one parameter of the set of parameters associated with one or more packets of the mesh network traffic. In some examples, the message component 610 may receive the WLAN traffic and mesh network traffic via a same radio of the device. In some cases, the type of event associated with the at least one event of the set of events of the WLAN traffic may include a WLAN connection event, a WLAN disconnection event, an enable WLAN radio event, a disable WLAN radio event, a resume WLAN traffic event, or a suspend WLAN traffic event, or any combination thereof. In some cases, the type of event associated with the at least one event of the set of events of the mesh network traffic includes an event for provisioning the device to a mesh network.

The comparison component 615 may compare the set of events of the WLAN traffic and the set of events of the mesh network traffic. In some examples, the comparison component 615 may compare the packet format of the mesh network traffic to the packet format of the WLAN traffic. The comparison component 615 may compare, by the host of the device, the type of event associated with the at least one event of the set of events of the WLAN traffic to the type of event associated with the at least one event of the set of events of the mesh network traffic.

The parameter component 620 may signal, by a host of the device to a controller of the device, the set of parameters. In some examples, the parameter component 620 may adjust a set of parameters based on comparing the set of events of the WLAN traffic and the set of events of the mesh network traffic. In some examples, the parameter component 620 may adjust the set of parameters based on assigning the priorities. In some examples, the parameter component 620 may adjust the set of parameters based on the comparison of the types of events. The parameter component 620 may allocate, by a host of the device, a bandwidth to the mesh network traffic based in part on the provisioning. The parameter component 620 may signal, from the host to a controller of the device, the allocation of the bandwidth using at least an application program interface to signal the controller of the device to adjust the bandwidth allocated to the mesh network traffic. The parameter component 620 may adjust a priority of the one or more packets of the mesh network traffic based in part on the second message, and signal from the host to a controller of the device, the adjusted priority using at least an application program interface to signal the controller of the device to adjust the priority of the mesh network traffic.

The traffic processing component 625 may process the mesh network traffic using adjusted set of parameters. The traffic processing component 625 may process, by the controller of the device, the mesh network traffic using adjusted bandwidth allocation associated with the mesh network traffic. The traffic processing component 625 may process, by the controller of the device, the mesh network traffic using adjusted scan duty cycle associated with the mesh network traffic.

The configuration component 630 may adjust a configuration of the controller based on at least one parameter of the set of parameters signaled from the host. In some examples, the configuration component 630 may adjust, by the controller of the device, a bandwidth allocation associated with the mesh network traffic or a bandwidth allocation associated with the WLAN traffic, or both based on the signaling received from the host of the device. In some examples, the configuration component 630 may adjust, by the controller of the device, a scan duty cycle associated with the mesh network traffic or a scan duty cycle associated with the WLAN traffic, or both based on the signaling received from the host of the device. In some examples, the configuration component 630 may assign, by the host of the device, a higher priority to the one or more packets associated with the mesh network traffic and a lower priority to the one or more packets associated with the WLAN traffic for a duration based on comparing the packet format of the mesh network traffic to the packet format of the WLAN traffic. In some examples, the configuration component 630 may select a length of the duration based on the packet format associated with one or more packets of the mesh network traffic.

The format component 635 may identify, by a host of the device, a packet format associated with one or more packets of the WLAN traffic and a packet format associated with one or more packets of the mesh network traffic.

As detailed above, the message component 610, the comparison component 615, the parameter component 620, the traffic processing component 625, the configuration component 630, and/or the format component 635 may perform and/or be a means for performing, either alone or in combination with other elements, one or more operations for supporting coexistence configuration switching for mesh networks.

FIG. 7 shows a diagram of a system 700 including a device 705 that supports coexistence configuration switching for mesh networks in accordance with aspects of the present disclosure. The device 705 may be an example of or include the components of device 405, device 505, or a STA as described herein. The device 705 may include components for bi-directional voice and data communications including components for transmitting and receiving communications, including a communications manager 710, an I/O controller 725, a transceiver 730, an antenna 735, memory 740, and a processor 745. These components may be in electronic communication via one or more buses (e.g., bus 750).

The communications manager 710 may receive at least one message associated with WLAN traffic and mesh network traffic, the message including a set of events of the WLAN traffic and a set of events of the mesh network traffic, compare the set of events of the WLAN traffic and the set of events of the mesh network traffic, adjust a set of parameters based on comparing the set of events of the WLAN traffic and the set of events of the mesh network traffic, and process the mesh network traffic using the adjusted set of parameters.

The communications manager 710 may also include a host 715 and a controller 720. These components may be in electronic communication via a host controller interface (HCI). In some examples, the host 715 and the controller 720 may be a single component or separate components of the device 705.

The host 715 may be software that supports (e.g., processes) of HCI events (e.g., WLAN traffic, mesh network traffic). In some examples, the host 715 may receive a packet, discover that an event has occurred based in part on the packet, and parse the received packet to determine which event occurred. For example, the host 715 may receive at least one message associated with WLAN traffic and mesh network traffic. The message may include a set of events of the WLAN traffic and a set of events of the mesh network traffic. The host 715 may then compare the set of events of the WLAN traffic and the set of events of the mesh network traffic, and adjust a set of parameters based in part on comparing the set of events of the WLAN traffic and the set of events of the mesh network traffic. The host 715 may signal to the controller 720 the set of adjusted parameter, such that the controller 720 may adjust a configuration of the controller 720 based in part on at least one parameter of the set of parameters signaled from the host 715.

The host 715 may identify a packet format associated with one or more packets of the WLAN traffic and a packet format associated with one or more packets of the mesh network traffic, and compare the packet format of the mesh network traffic to the packet format of the WLAN traffic. Based on the comparison, the host 715 may assign a higher priority to the one or more packets associated with the mesh network traffic and a lower priority to the one or more packets associated with the WLAN traffic for a duration (e.g., period) based in part on comparing the packet format of the mesh network traffic to the packet format of the WLAN traffic. Here, the adjusted set of parameters may be based in part on assigning the priorities. The host 715 may also select a length of the duration based in part on the packet format associated with one or more packets of the mesh network traffic.

The host 715 may receive a second message, from an application (e.g., via an API) of the device 705. The second message may include instructions to adjust at least one parameter of the set of parameters associated with one or more packets of the mesh network traffic. In this example, the host 715 may adjust a priority of the one or more packets of the mesh network traffic based in part on the second message, and signal, from the host 715 to the controller 720 of the device 705, the adjusted priority using at least an API to signal the controller 720 of the device 705 to adjust the priority of the mesh network traffic.

The host 715 may additionally, or alternatively, identify a type of event associated with at least one event of the set of events of the WLAN traffic and a type of event associated with at least one event of the set of events of the mesh network traffic. Here, the host 715 may adjust the set of parameters based in part on the comparison of the types of events. The type of event associated with the at least one event of the set of events of the WLAN traffic may include a WLAN connection event, a WLAN disconnection event, an enable WLAN radio event, a disable WLAN radio event, a resume WLAN traffic event, or a suspend WLAN traffic event, or any combination thereof. The type event associated with the at least one event of the set of events of the mesh network traffic may include an event for provisioning the device 705 to a mesh network. By way of example, as part of a provisioning event, the host 715 may receive an indication to provision the device 705 to a mesh network. Here, the host 715 may allocate a bandwidth to the mesh network traffic based in part on the provisioning, and signal, from the host 715 to the controller 720 of the device 705, the allocation of the bandwidth using at least an API to signal the controller 720 of the device 705 to adjust the bandwidth allocated to the mesh network traffic.

The controller 720 may be firmware that supports (e.g., processes) HCI commands for WLAN and mesh network traffic (e.g., Bluetooth mesh network traffic), for example, by accessing baseband commands, link manager commands, hardware status registers, control registers, and event registers. In some examples, the controller 720 may receive the set of adjusted parameter from the host 715, and adjust a configuration (e.g., bandwidth allocation, priority, and the like). In some examples, the controller 720 may adjust a bandwidth allocation associated with the mesh network traffic or a bandwidth allocation associated with the WLAN traffic, or both, and process the mesh network traffic using the adjusted bandwidth allocation.

In other examples, the controller 720 may adjust a scan duty cycle associated with the mesh network traffic or a scan duty cycle associated with the WLAN traffic, or both, and process the mesh network traffic using the adjusted scan duty cycle. The controller 720 of the device 705 may receive signaling, from the host 715, the allocation of the bandwidth using at least an API, and adjust a configuration (e.g., the bandwidth allocated to the mesh network traffic) based in part on the signaling. In some examples, the controller 720 of the device 705 may receive signaling, from the host 715, to adjust a configuration based in part on the adjusted priority of the mesh network traffic.

I/O controller 725 may manage input and output signals for device 705. I/O controller 725 may also manage peripherals not integrated into device 705. In some cases, I/O controller 725 may represent a physical connection or port to an external peripheral. In some cases, I/O controller 725 may utilize an operating system such as iOS, ANDROID, MS-DOS, MS-WINDOWS, OS/2, UNIX, LINUX, or another known operating system. In other cases, I/O controller 725 may represent or interact with a modem, a keyboard, a mouse, a touchscreen, or a similar device. In some cases, I/O controller 725 may be implemented as part of a processor. In some cases, a user may interact with device 705 via I/O controller 725 or via hardware components controlled by I/O controller 725.

Transceiver 730 may communicate bi-directionally, via one or more antennas, wired, or wireless links as described above. For example, the transceiver 730 may represent a wireless transceiver and may communicate bi-directionally with another wireless transceiver. The transceiver 730 may also include a modem to modulate the packets and provide the modulated packets to the antennas for transmission, and to demodulate packets received from the antennas. In some examples, the device 705 may include a single antenna 735. However, in some examples, the device 705 may have more than one antenna 735, which may be capable of concurrently transmitting or receiving multiple wireless transmissions. In some examples, the device 705 may receive the WLAN traffic and the mesh network traffic via a same radio (e.g., the transceiver 730, the antenna 735).

Memory 740 may include RAM and ROM. The memory 740 may store computer-readable, computer-executable software including instructions that, when executed, cause the processor to perform various functions described herein. In some cases, the memory 740 may contain, among other things, a BIOS which may control basic hardware or software operation such as the interaction with peripheral components or devices.

Processor 745 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, processor 745 may be configured to operate a memory array using a memory controller. In other cases, a memory controller may be integrated into processor 745. Processor 745 may be configured to execute computer-readable instructions stored in a memory to perform various functions (e.g., functions or tasks supporting coexistence configuration switching for mesh networks).

As detailed above, the communications manager 710 and/or one or more components of the communications manager 710 may perform and/or be a means for performing, either alone or in combination with other elements, one or more operations for supporting coexistence configuration switching for mesh networks.

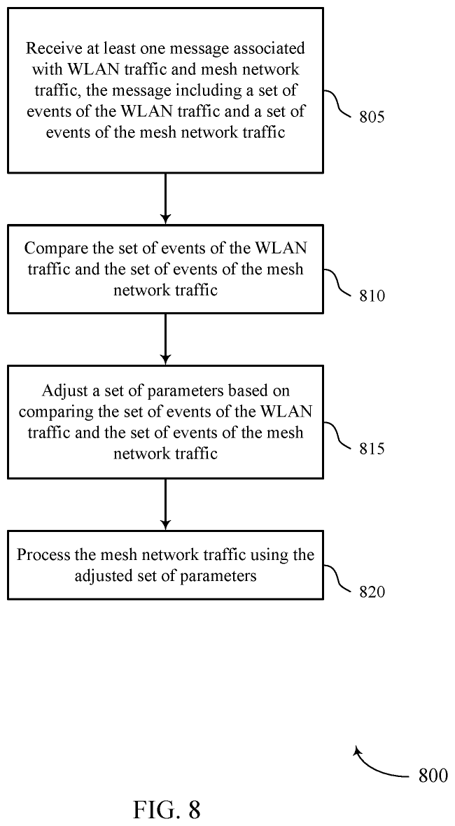

FIG. 8 shows a flowchart illustrating a method 800 that supports coexistence configuration switching for mesh networks in accordance with aspects of the present disclosure. The operations of method 800 may be implemented by a STA or its components as described herein. For example, the operations of method 800 may be performed by a communications manager as described with reference to FIGS. 4 through 7. In some examples, a STA may execute a set of instructions to control the functional elements of the STA to perform the functions described below. Additionally, or alternatively, a STA may perform aspects of the functions described below using special-purpose hardware.

At 805, the STA may receive at least one message associated with WLAN traffic and mesh network traffic, the message including a set of events of the WLAN traffic and a set of events of the mesh network traffic. The operations of 805 may be performed according to the methods described herein. In some examples, aspects of the operations of 805 may be performed by a message component as described with reference to FIGS. 4 through 7.

At 810, the STA may compare the set of events of the WLAN traffic and the set of events of the mesh network traffic. The operations of 810 may be performed according to the methods described herein. In some examples, aspects of the operations of 810 may be performed by a comparison component as described with reference to FIGS. 4 through 7.

At 815, the STA may adjust a set of parameters based on comparing the set of events of the WLAN traffic and the set of events of the mesh network traffic. The operations of 815 may be performed according to the methods described herein. In some examples, aspects of the operations of 815 may be performed by a parameter component as described with reference to FIGS. 4 through 7.

At 820, the STA may process the mesh network traffic using the adjusted set of parameters. The operations of 820 may be performed according to the methods described herein. In some examples, aspects of the operations of 820 may be performed by a traffic processing component as described with reference to FIGS. 4 through 7.

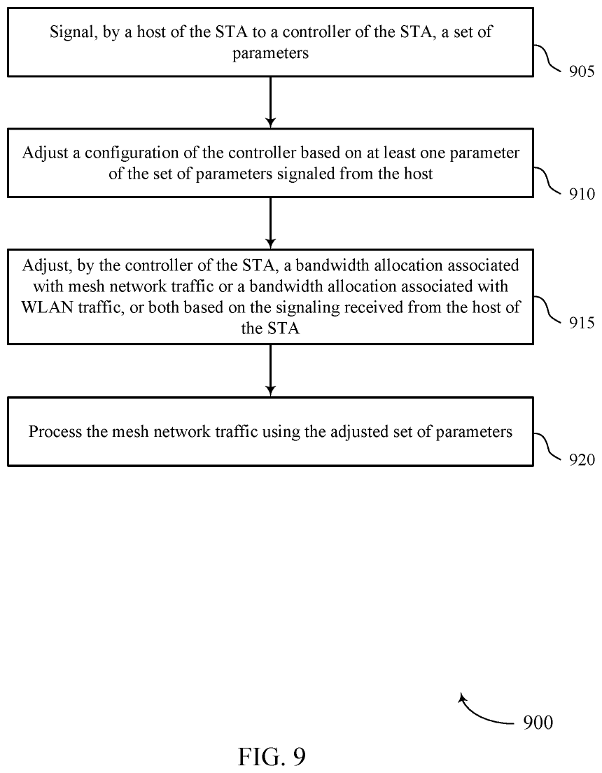

FIG. 9 shows a flowchart illustrating a method 900 that supports coexistence configuration switching for mesh networks in accordance with aspects of the present disclosure. The operations of method 900 may be implemented by a STA or its components as described herein. For example, the operations of method 900 may be performed by a communications manager as described with reference to FIGS. 4 through 7. In some examples, a STA may execute a set of instructions to control the functional elements of the STA to perform the functions described below. Additionally, or alternatively, a STA may perform aspects of the functions described below using special-purpose hardware.

At 905, the STA may signal, by a host of the STA to a controller of the STA, a set of parameters. The operations of 905 may be performed according to the methods described herein. In some examples, aspects of the operations of 905 may be performed by a parameter component as described with reference to FIGS. 4 through 7.

At 910, the STA may adjust a configuration of the controller based on at least one parameter of the set of parameters signaled from the host. The operations of 910 may be performed according to the methods described herein. In some examples, aspects of the operations of 910 may be performed by a configuration component as described with reference to FIGS. 4 through 7.

At 915, the STA may adjust, by the controller of the STA, a bandwidth allocation associated with the mesh network traffic or a bandwidth allocation associated with the WLAN traffic, or both based on the signaling received from the host of the STA. The operations of 915 may be performed according to the methods described herein. In some examples, aspects of the operations of 915 may be performed by a configuration component as described with reference to FIGS. 4 through 7.

At 920, the STA may process the mesh network traffic using the adjusted set of parameters. The operations of 920 may be performed according to the methods described herein. In some examples, aspects of the operations of 920 may be performed by a traffic processing component as described with reference to FIGS. 4 through 7.

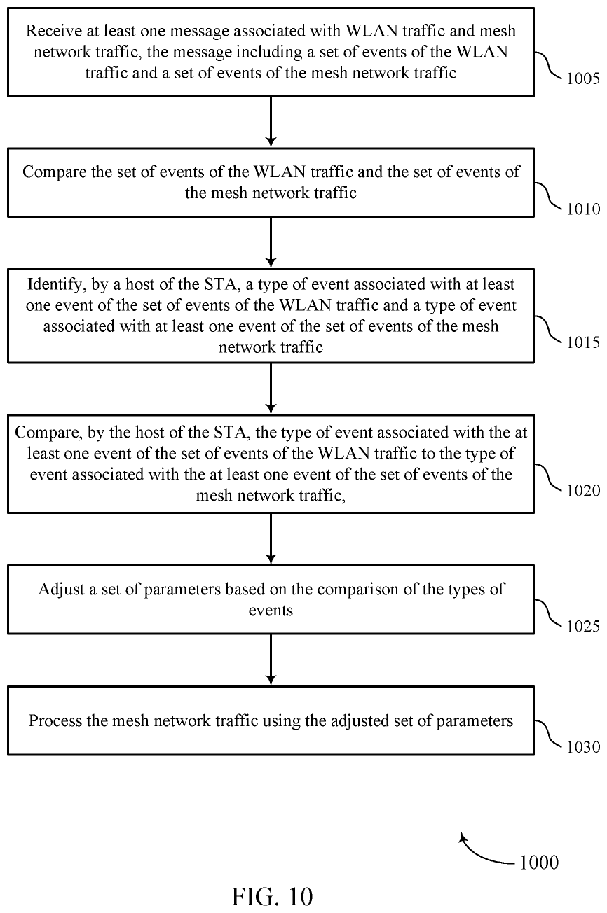

FIG. 10 shows a flowchart illustrating a method 1000 that supports coexistence configuration switching for mesh networks in accordance with aspects of the present disclosure. The operations of method 1000 may be implemented by a STA or its components as described herein. For example, the operations of method 1000 may be performed by a communications manager as described with reference to FIGS. 4 through 7. In some examples, a STA may execute a set of instructions to control the functional elements of the STA to perform the functions described below. Additionally, or alternatively, a STA may perform aspects of the functions described below using special-purpose hardware.

At 1005, the STA may receive at least one message associated with WLAN traffic and mesh network traffic, the message including a set of events of the WLAN traffic and a set of events of the mesh network traffic. The operations of 1005 may be performed according to the methods described herein. In some examples, aspects of the operations of 1005 may be performed by a message component as described with reference to FIGS. 4 through 7.

At 1010, the STA may compare the set of events of the WLAN traffic and the set of events of the mesh network traffic. The operations of 1010 may be performed according to the methods described herein. In some examples, aspects of the operations of 1010 may be performed by a comparison component as described with reference to FIGS. 4 through 7.

At 1015, the STA may identify, by a host of the STA, a type of event associated with at least one event of the set of events of the WLAN traffic and a type of event associated with at least one event of the set of events of the mesh network traffic. The operations of 1015 may be performed according to the methods described herein. In some examples, aspects of the operations of 1015 may be performed by a message component as described with reference to FIGS. 4 through 7.

At 1020, the STA may compare, by the host of the STA, the type of event associated with the at least one event of the set of events of the WLAN traffic to the type of event associated with the at least one event of the set of events of the mesh network traffic. The operations of 1020 may be performed according to the methods described herein. In some examples, aspects of the operations of 1020 may be performed by a comparison component as described with reference to FIGS. 4 through 7.

At 1025, the STA may adjust a set of parameters based on the comparison of the types of events. The operations of 1025 may be performed according to the methods described herein. In some examples, aspects of the operations of 1025 may be performed by a parameter component as described with reference to FIGS. 4 through 7.

At 1030, the STA may process the mesh network traffic using the adjusted set of parameters. The operations of 1030 may be performed according to the methods described herein. In some examples, aspects of the operations of 1030 may be performed by a traffic processing component as described with reference to FIGS. 4 through 7.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. A CDMA system may implement a radio technology such as CDMA2000, Universal Terrestrial Radio Access (UTRA), etc. CDMA2000 covers IS-2000, IS-95, and IS-856 standards. IS-2000 Releases may be commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM).

An OFDMA system may implement a radio technology such as Ultra Mobile Broadband (UMB), Evolved UTRA (E-UTRA), Institute of Electrical and Electronics Engineers (IEEE) 802.11 (Wi-Fi), IEEE 802.16 (WiMAX), IEEE 802.20, Flash-OFDM, etc. UTRA and E-UTRA are part of Universal Mobile Telecommunications System (UMTS). LTE, LTE-A, and LTE-A Pro are releases of UMTS that use E-UTRA. UTRA, E-UTRA, UMTS, LTE, LTE-A, LTE-A Pro, NR, and GSM are described in documents from the organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned herein as well as other systems and radio technologies. While aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR applications.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communications at a device, comprising:
receiving at least one message associated with wireless local area network traffic and mesh network traffic, the message comprising a set of events of the wireless local area network traffic and a set of events of the mesh network traffic;
comparing the set of events of the wireless local area network traffic and the set of events of the mesh network traffic;
adjusting a set of parameters based at least in part on comparing the set of events of the wireless local area network traffic and the set of events of the mesh network traffic; and
processing the mesh network traffic using the adjusted set of parameters.

2. The method of claim 1, further comprising:
signaling, by a host of the device to a controller of the device, the set of parameters; and
adjusting a configuration of the controller based at least in part on at least one parameter of the set of parameters signaled from the host.

3. The method of claim 2, further comprising:
adjusting, by the controller of the device, a bandwidth allocation associated with the mesh network traffic or a bandwidth allocation associated with the wireless local area network traffic, or both based at least in part on the signaling received from the host of the device,
wherein processing the mesh network traffic comprises:
processing, by the controller of the device, the mesh network traffic using the adjusted bandwidth allocation associated with the mesh network traffic.

4. The method of claim 2, further comprising:
adjusting, by the controller of the device, a scan duty cycle associated with the mesh network traffic or a scan duty cycle associated with the wireless local area network traffic, or both based at least in part on the signaling received from the host of the device,
wherein processing the mesh network traffic comprises:
processing, by the controller of the device, the mesh network traffic using the adjusted scan duty cycle associated with the mesh network traffic.

5. The method of claim 1, further comprising:
identifying, by a host of the device, a packet format associated with one or more packets of the wireless local area network traffic and a packet format associated with one or more packets of the mesh network traffic;
comparing the packet format of the mesh network traffic to the packet format of the wireless local area network traffic; and
assigning, by the host of the device, a higher priority to the one or more packets associated with the mesh network traffic and a lower priority to the one or more packets associated with the wireless local area network traffic for a duration based at least in part on comparing the packet format of the mesh network traffic to the packet format of the wireless local area network traffic,
wherein adjusting the set of parameters is based at least in part on assigning the priorities.

6. The method of claim 5, further comprising:
selecting a length of the duration based at least in part on the packet format associated with one or more packets of the mesh network traffic.

7. The method of claim 1, further comprising:
identifying, by a host of the device, a type of event associated with at least one event of the set of events of the wireless local area network traffic and a type of event associated with at least one event of the set of events of the mesh network traffic; and
comparing, by the host of the device, the type of event associated with the at least one event of the set of events of the wireless local area network traffic to the type of event associated with the at least one event of the set of events of the mesh network traffic,
wherein adjusting the set of parameters is further based at least in part on the comparison of the types of events.

8. The method of claim 7, wherein the type of event associated with the at least one event of the set of events of the wireless local area network traffic comprises a wireless local area network connection event, a wireless local area network disconnection event, an enable wireless local area network radio event, a disable wireless local area network radio event, a resume wireless local area network traffic event, or a suspend wireless local area network traffic event, or any combination thereof.

9. The method of claim 7, wherein the type of event associated with the at least one event of the set of events of the mesh network traffic comprises an event for provisioning the device to a mesh network.

10. The method of claim 1, further comprising:
receiving an indication to provision the device to a mesh network, wherein at least one event of the set of events of the mesh network traffic comprises the provisioning;
wherein adjusting the set of parameters comprises:
allocating, by a host of the device, a bandwidth to the mesh network traffic based at least in part on the provisioning; and
signaling, from the host to a controller of the device, the allocation of the bandwidth using at least an application program interface to signal the controller of the device to adjust the bandwidth allocated to the mesh network traffic.

11. The method of claim 1, further comprising:
receiving, by a host of the device, a second message from an application of the device, the second message comprising instructions to adjust at least one parameter of the set of parameters associated with one or more packets of the mesh network traffic;
wherein adjusting the set of parameter comprises:
adjusting a priority of the one or more packets of the mesh network traffic based at least in part on the second message; and
signaling, from the host to a controller of the device, the adjusted priority using at least an application program interface to signal the controller of the device to adjust the priority of the mesh network traffic.

12. The method of claim 1, wherein receiving the message comprises:
receiving, by a host of the device, the message comprising the set of events of the wireless local area network traffic and the set of events of the mesh network traffic.

13. The method of claim 1, further comprising:
receiving the wireless local area network traffic and mesh network traffic via a same radio of the device.

14. An apparatus for wireless communications, comprising:
a processor, memory in electronic communication with the processor; and
instructions stored in the memory and executable by the processor to cause the apparatus to:
receive at least one message associated with wireless local area network traffic and mesh network traffic, the message comprising a set of events of the wireless local area network traffic and a set of events of the mesh network traffic;
compare the set of events of the wireless local area network traffic and the set of events of the mesh network traffic;
adjust a set of parameters based at least in part on comparing the set of events of the wireless local area network traffic and the set of events of the mesh network traffic; and
process the mesh network traffic using the adjusted set of parameters.

15. The apparatus of claim 14, wherein the instructions are further executable by the processor to cause the apparatus to:
signal, by a host of the apparatus to a controller of the apparatus, the set of parameters; and
adjust a configuration of the controller based at least in part on at least one parameter of the set of parameters signaled from the host.

16. The apparatus of claim 15, wherein the instructions are further executable by the processor to cause the apparatus to:
adjust, by the controller of the apparatus, a bandwidth allocation associated with the mesh network traffic or a bandwidth allocation associated with the wireless local area network traffic, or both based at least in part on the signaling received from the host of the apparatus,
wherein processing the mesh network traffic comprises.

17. The apparatus of claim 15, wherein the instructions are further executable by the processor to cause the apparatus to:
adjust, by the controller of the apparatus, a scan duty cycle associated with the mesh network traffic or a scan duty cycle associated with the wireless local area network traffic, or both based at least in part on the signaling received from the host of the apparatus,
wherein processing the mesh network traffic comprises.

18. The apparatus of claim 14, wherein the instructions are further executable by the processor to cause the apparatus to:
identify, by a host of the apparatus, a packet format associated with one or more packets of the wireless local area network traffic and a packet format associated with one or more packets of the mesh network traffic;
compare the packet format of the mesh network traffic to the packet format of the wireless local area network traffic;
assign, by the host of the apparatus, a higher priority to the one or more packets associated with the mesh network traffic and a lower priority to the one or more packets associated with the wireless local area network traffic for a duration based at least in part on comparing the packet format of the mesh network traffic to the packet format of the wireless local area network traffic,
wherein adjusting the set of parameters is based at least in part on assigning the priorities.

19. An apparatus for wireless communications, comprising:
means for receiving at least one message associated with wireless local area network traffic and mesh network traffic, the message comprising a set of events of the wireless local area network traffic and a set of events of the mesh network traffic;
means for comparing the set of events of the wireless local area network traffic and the set of events of the mesh network traffic;
means for adjusting a set of parameters based at least in part on comparing the set of events of the wireless local area network traffic and the set of events of the mesh network traffic; and
means for processing the mesh network traffic using the adjusted set of parameters.

20. The apparatus of claim 19, further comprising:
means for signaling, by a host of the apparatus to a controller of the apparatus, the set of parameters; and
means for adjusting a configuration of the controller based at least in part on at least one parameter of the set of parameters signaled from the host.
